(19) United States
(12) Patent Application Publication
(10) Pub. No.: US 2013/0337210 A1
(43) Pub. Date: Dec. 19, 2013

(54) GAS PHASE POLYMERISATION OF ETHYLENE

(71) Applicant: Saudi Basic Industries Corporation, Riyadh (SA)

(72) Inventors: Vugar O. Aliyev, Riyadh (SA); Jose Fernando Cevallos-Candau, Charleston, WV (US)

(21) Appl. No.: 13/918,090

(22) Filed: Jun. 14, 2013

(30) Foreign Application Priority Data
Jun. 15, 2012 (EP) 12075060.9

(51) Int. Cl. C08F 110/02

(52) U.S. Cl. CPC C08F 110/02
USPC 428/36.92; 526/130; 526/113; 526/352

(57) ABSTRACT

The disclosed process is for the production of polyethylene by gas phase polymerisation of ethylene in the presence of a supported chromium oxide based catalyst which is modified with an amino alcohol wherein the molar ratio of amino alcohol:chromium ranges between 0.5:1 and 1:1, wherein the support is silica having a surface area (SA) between 250 m²/g and 400 m²/g and a pore volume (PV) between 1.1 cm³/g and less than 2.0 cm³/g and wherein the amount of chromium in the supported catalyst is at least 0.1% by weight and less than 0.5% by weight.

### CROSS REFERENCE TO RELATED APPLICATIONS

The present application claims priority to European Application Ser. No. 12075060.9, filed Jun. 15, 2012, whose contents are incorporated herein in their entirety by reference.

The present invention relates to a process for the gas phase polymerisation of ethylene in the presence of a supported chromium oxide based catalyst.

The production processes of LDPE, HDPE and LLDPE are summarised in “Handbook of Polyethylene” by Andrew Peacock (2000; Dekker; ISBN 0824795466) at pages 43-66. The catalysts can be divided in three different subclasses including Ziegler Natta catalysts, Phillips catalysts and single site catalysts. The various processes may be divided into solution polymerisation processes employing homogeneous (soluble) catalysts and processes employing supported (heterogeneous) catalysts. The latter processes include gas phase processes.

The chromium oxide based catalyst, which is commonly referred to in the literature as “the Phillips catalyst”, can be obtained by calcining a chromium compound carried on an inorganic oxide carrier in a non-reducing atmosphere. The chromium oxide catalysis and the ethylene polymerisation with this specific catalyst are disclosed in “Handbook of Polyethylene” by Andrew Peacock at pages 61-64.

A gas phase reactor is essentially a fluidised bed of dry polymer particles maintained either by stirring or by passing gas (ethylene) at high speeds through it. The obtained powder is mixed with stabilizers and generally extruded into pellets. Gas fluidized bed polymerisation processes are summarised by Than Chee Mun in Hydrocarbons 2003 “Production of polyethylene using gas fluidised bed reactor”. Gas phase polymerisation generally involves adding gaseous monomers into a vertically oriented polymerisation reactor filled with previously formed polymer, catalyst particles and additives. Generally the polymerisation in the gas phase polymerisation systems takes place at temperatures between 30° C. and 130° C. with super atmospheric pressures. The rising gas phase fluidizes the bed, and the monomers contained in the gas phase polymerize onto supported catalyst or preformed polymer during this process. Upon reaching the top of the reactor, unreacted monomer is recycled, while polymer continually falls down along the sides of the reactor. Examples of suitable gas phase polymerisations are disclosed in for example U.S. Pat. No.4,003,712 and U.S.-A-2005/0137364.

Gas phase, fluidized bed reactors consist of a straight section where the great majority of the material is fluidized, and a de-entrainment section, usually of higher diameter, where the particles carried over by the fluidization gas are removed from the gas by virtue of the reduced velocity and therefore reduced momentum of the particles. This part of the reactor is usually called the expanded section; the top of the reactor is usually semi-spherical and is referred as the dome of the reactor. This space where de-entrainment occurs can also be called the “free board”. The de-entrainment of particles in the free board is highly dependent on the particle size of the material on the straight section. The gas velocity used to fluidize the bed (called Superficial Gas Velocity of SGV) is calculated using the average particle size distribution of APS of the resin in the bed. However, if the polymer is rich in fines, the de-entrainment in the freeboard can be incomplete and there will be carryover of particles to other sections of the reactor, where their presence can have undesirable effects. There are several undesirable effects of having fines carryover. The small particles are prone to high static electricity and are rich in catalyst. When these particles accumulate in stagnant areas such as the dome of the reactor or the walls of the expanded section, they can continue to polymerize without the benefit of proper removal of the heat of polymerization, resulting in molten polymer, and forming what is known to those familiar with the art as chunks and/or sheets. Another undesirable effect of particle carryover is the accumulation of materials in the cooler used to remove the heat of polymerization, leading to reduced efficiency of the cooler and in extreme cases blocking the gas flow to a point where there is not enough velocity to fluidize the bed. Fines can also accumulate inside the recycle lines and also under the gas distribution plate where they can eventually disrupt fluidization to the point where operation of the reactor has to stop for cleaning and removal of fines at great economic loss. The presence of fines can also affect product quality. The presence of fines during the production of high density polyethylene in a gas phase reactor with chromium based catalysts is a problem. Fines that accumulate on the dome or on other relatively cold surfaces continue to react at a lower temperature and form gels due to the formation of ultra high molecular weight material. The properties of the final products can be greatly affected by the presence of gels; thus resins containing gels are often classified as off-grade material at a great economic loss. Many solutions to the problem of entrained fines have been proposed. These solutions are unsatisfactory since they can reduce the production capacity of a plant or add substantial capital costs to the production equipment; moreover, they can add complications to the operation of the reactor and even increase risks to the safe operation of a plant. Those skilled in the operation of gas phase polymerization reactors have strategies to limit the problems associated with gels. One solution is the reduce the SGV of the fluidization gas to limit the carryover; this solution is not only inherently limited by so called “minimum fluidization velocity” needed to operate the reactor but reduces the efficiency of the cooler and thus production rates are also reduced with an economic penalty. Another strategy is to stop production at scheduled intervals to clean the reactor; this also results in a significant economic penalty due to production loss.

U.S. Pat. No. 5,912,309 discloses the use of sonic cleaner blasters to continually remove fines that accumulate on the expanded section of the reactor as a result of entrainment. This solution is unsatisfactory in that not only the source of the problem is not eliminated but the sonic cleaners are expensive, they add operational complications and produce vibrations that can ultimately affect the safe performance of the reactor.

U.S. Pat. No. 4,882,400 discloses the use of a cyclone to concentrate the entrained particles from the freeboard and to then reintroduce said particles back to the reactor. This solution adds complexity and cost to the process and does not address the generation of fines. Ethylene polymerization is a very exothermic process; therefore removal of heat of reaction is crucial for stable operation of polyethylene production reactors. In the case of gas phase, fluidized bed reactors, the heat of polymerization is removed from the fluidization gas via the use of a cooler that is external to the fluidized bed. Improved heat removal efficiency is critical and it is often the factor limiting production rates. Any improvement in heat removal efficiency is highly desirable as it can result in increased production rates. The cooling capacity of a heat exchanger can be increased by increasing the mass flow rate of the fluidizing gas as it circulates around the fluidized bed, this can be achieved by increasing the SGV of the gas. However, the maximum limit for the SGV is determined by the need to prevent entrainment for the fluidized bed. There are several factors that determine entrainment; fines being one of them. Another factor is the APS of the resin and the bulk density of the particles. A catalyst that produces polymer with larger APS with little or no fines while maintaining good bulk density is therefore desirable for polymerization processes, as it enables operation at higher SGV. Another strategy used to increase heat removal while producing high density polyethylene is to increase the heat capacity (Cₚ) of the fluidizing gas. This is most commonly done by adding a hydrocarbon of a higher molecular weight than ethylene.

U.S. 2005/0137364 A1 discloses several hydrocarbons that could be used to increase the Cₚ of the fluidization gas. A disadvantage of this approach is that the momentum of the gas is also increased and therefore the risk of resin carryover. In this circumstance a catalyst with high APS, low fines and good bulks density is also advantageous.

It is the object of the present invention is to provide a gas phase process for the manufacturing of high density polyethylene which results in a polymer with narrower particle size distribution and larger average particle size.

The present invention provides a process wherein high density ethylene polymer is obtained by polymerizing of ethylene in the presence of a supported chromium oxide based catalyst composition which is modified with an amino alcohol wherein the molar ratio of amino alcohol:chromium ranges between 0.5:1 and 1:1, wherein the support is silica having a surface area (SA) between 250 m²/g and 400 m²/g and a pore volume (PV) between 1.1 cm³/g and less than 2.0 cm³/g and wherein the amount of chromium in the supported catalyst is at least 0.1% by weight and less than 0.5% by weight.

The amino alcohol has the formula:

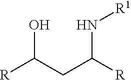

wherein

the R groups may be ,independently of one other the same or different, a C₁-C₁₀ alkyl group and

R¹ is a C₃-C₈ cycloalkyl group or C₄-C₁₆ alkyl substituted cycloalkyl group

According to a preferred embodiment of the invention the amino alcohol is 4-(cyclohexylamino) pentan-2-ol or 4-[(2-methylcyclohexyl) amino]pentan-2-ol.

The invention results in increased catalyst activity and increased productivity. Polyethylene with narrower particle size distribution and larger average particle size is obtained. Further advantages are the improved bulk density, the shifting of the particle size distribution to larger particles and the reduced concentration of fines in the bulk of the resin.

In the case that the molar ratio of amino alcohol:chromium is outside the claimed range between 0.5:1 and 1:1 the desired results are not obtained as shown in the comparative examples of the present application. Advantages according to the present invention for example increased catalyst activity and productivity, larger average particle size, shifting of the particle size distribution to larger particles and the reduced concentration of fines in the bulk of the resin are not obtained when the ratio of amino alcohol to chromium is above 1:1. If the molar ratio of amino alcohol: chromium is less than 0.5:1 no improvement is observed.

According to a preferred embodiment of the invention the molar ratio of amino alcohol: chromium ranges between 0.7:1 and 0.9:1.

It is not desirable in the present gas phase process to apply a catalyst having a pore volume (PV) higher than 2.0 cm³/g because this will reduce the upper fluidised bulk density of the resin the gas phase process which will force to reduce the super gas velocity otherwise the resin will carryover and result in fouling of the reactor. The reduction of the super gas velocity results in a reduction of the production rate.

The catalyst composition may also comprise a titanium compound. Generally, the titanium content of the catalyst ranges between 0.1 and 10% by weight, preferably in the range between 0.1 and 6% by weight.

The titanium compound may be a compound according to the formulas Ti (OR¹)ₙX₄₋ₙ and Ti (R²)ₙX₄₋ₙ, wherein

R¹ and R² represent an (C₁-C₂₀) alkyl group, (C₁-C₂₀) aryl group or (C₁-C₂₀) cycloalkyl group,

X represents a halogen atom, preferably chlorine, and

n represents a number satisfying 0≧n≦4.

Examples of suitable titanium compounds include titanium alkoxy compounds for example tetraethoxy titanium, tetramethoxy titanium, tetrabutoxy titanium, tetrapropoxy titanium, tetraisobutoxy titanium, tetrapentoxy titanium, triethoxychloro titanium, diethoxydichloro titanium, trichloethoxy titanium, methoxy titanium trichloride, dimethoxy titanium dichloride, ethoxy titanium trichloride, diethoxy titanium dichloride, propoxy titanium trichloride, dipropoxy titanium dichloride, butoxy titanium trichloride, butoxy titanium dichloride and titanium tetrachloride. Preferably titanium tetraisopropoxide is applied.

The weight ratio Cr:Ti may range for example between 1:2 and 1:4.

The presence of titanium may increase the activity of the catalyst, first by shortening the induction time, and then by allowing higher polymerization rates. Furthermore the presence of titanium may result in broadening the polymer molecular weight distribution (MWD) which increases the melt index which can be useful in for example blow moulding applications.

The chromium oxide based catalyst contains a support. Preferably the support is a silica support. The silica may have a surface area (SA) larger than 150 m²/g and a pore volume (PV) larger than 0.8 cm³/g and less than 2.0 cm³/g.

More preferably the silica has a surface area (SA) between 250 m²/g and 400 m²/g and a pore volume (PV) between 1.1 cm³/g and less than 2.0 cm³/g.

Preferably the amount of chromium in the supported catalyst is at least 0.1% by weight and less than 0.5% by weight. Preferably the amount of chromium is at least 0.2% by weight, more preferably at least 0.3% by weight. Preferably the amount of chromium in the supported catalyst ranges between 0.3 and 0.5% by weight.

In the case of the production of an ethylene copolymer the alpha olefin co monomer may be propylene, 1-butene, 1-pentene, 4-methyl-l-pentene, 1-hexene and/or 1-octene.

The polyethylene powder obtained with the process according to the present invention has:

a high-load melt index (HLMI) >5 g/10 min and <30 g/10 min (according to ISO 1133)

M_{w}/Mₙ ≧15 and ≦35 (according to size exclusion chromatography (SEC) measurement)

a density ≧935 kg/m³ and ≦960 kg/m³ (according to ISO1183).

The ethylene polymers obtained with the process according to the invention may be combined with additives such as for example lubricants, fillers, stabilisers, antioxidants, compatibilizers and pigments. The additives used to stabilize the polymers may be, for example, additive packages including hindered phenols, phosphites, UV stabilisers, antistatics and stearates.

Ethylene polymers may be extruded or blow-moulded into articles such as for example pipes, bottles, containers, fuel tanks and drums, and may be extruded or blown into films. According to a preferred embodiment of the present invention the ethylene polymer is applied to produce bottles or containers via a blow moulding process.

The nature of the silica support, the chromium loading, and the activation method can all influence the chemical state of the supported chromium and performance of the chromium oxide on silica catalyst in the polymerization process. For example, the activity of the catalysts generally increases with an increase in the activation temperature, while the molar mass of the polymerization product may decrease or the HLMI (High Load Melt Index) may increase. The influence of the activation conditions on the catalyst properties is disclosed in Advances in Catalysis, Mc Daniel, Vol. 33, 48-98, 1985. Generally the activation takes place at an elevated temperature, for example, at a temperature above 450° C., preferably from 450 to 850° C. The activation may take place in different atmosphere, for example in dry air. Generally, the activation takes place at least partially under an inert atmosphere preferably consisting of nitrogen. The activation time after reaching the maximum temperature may last for several minutes to several hours. This activation time is at least 1 hour but it may be advantageous to activate much longer. Depending on the specific application requirements, chromium oxide catalyst can be activated at different temperatures and time periods before contacting with the amino alcohol according to the invention. For example, for blow moulded IBCs (Intermediate Bulk Containers) the catalyst activation temperature ranges preferably between 538 and 705° C. For blow moulded HICs (Household Industrial Containers) the catalyst activation temperatures are preferably in the range between 600 and 850° C.

WO2010063445 discloses an ethylene copolymer obtained by polymerising ethylene and 1-hexene in a slurry loop reactor in the presence of a silica-supported chromium containing catalyst and triethyl boron wherein the silica-supported chromium-containing catalyst is a silica-supported chromium catalyst having a pore volume larger than 2.0 cm³/g and a specific surface area of at least 450 m²/gram and wherein the amount of chromium in the catalyst is at least 0.5% by weight and wherein the concentration of boron is less than 0.20 ppm. In contrast the process according to the present invention is directed to an ethylene copolymer obtained by polymerising ethylene in a gas phase process in the presence of a silica-supported chromium containing catalyst and in the absence of a boron compound wherein the silica-supported chromium-containing catalyst is a silica-supported chromium catalyst having a pore volume less than 2.0 cm³/g and a specific surface area less than 400 m²/gram, wherein the amount of chromium in the catalyst is less than 0.5% by weight and wherein no boron is present.

WO2012045426 discloses the polymerisation in slurry of ethylene in the presence of a supported chromium oxide based catalyst which is modified with an organic compound comprising oxygen and nitrogen for example saturated heterocyclic organic compounds with a five or six membered ring, amino esters and amino alcohols, to obtain polyethylene having a broader MWD which may be applied in the production of pipes. The molar ratio chromium to catalyst modifier, meaning the moles chromium divided by the moles catalyst modifier, ranges between 1:0.05 and 1:3, i.e. between 20 and 0.33.Preferably, the molar ratio chromium to catalyst modifier ranges between 1:0.1 and 1:1, i.e. between 10 and 1. The amount of chromium in the supported catalyst ranges between 0.5 and 2.0% by weight.

The invention will be elucidated by means of the following non-limiting examples.

### EXAMPLES

### Example I

A silica supported chromium oxide based catalyst with 0.38 wt % of chromium, 1.8 wt % of titanium, a surface area of 300 m²/g and a pore volume of 1.5 cm³/g was activated in an atmosphere of dry air at a temperature of 825° C. for 3 hours using a tube furnace. 300 grams of previously activated catalyst is placed in a 1 L flask. Dry degassed hexane is added and the mixture is heated to 50° C. Then amino alcohol [4-(cyclohexylamino) pentan-2-ol] as a 1M solution in dry hexane is added via syringe. The mixture is reacted for 1 hour at 50° C. with occasional shaking of the flask. The slurry is then dried under high vacuum or with a nitrogen purge. The modified catalyst is stored under nitrogen until used. The catalyst was yellow. The calculated amino alcohol to Cr mole ratio was 0.8:1.

### Comparative Example A

The procedure used to make catalyst as described in Example I is repeated except that no amino alcohol [4-(cyclohexylamino) pentan-2-ol] is present.

### Example II and Comparative Example B

### Gas Phase Polymerization.

The catalysts according to Example I and Comparative Example A were used in a gas phase polymerisation of ethylene. The results are summarized in Table 1.

### Comparative Example C

Examples I and II are repeated with the exception that the calculated amino alcohol to Cr mole ratio was 1.2:1.The catalyst productivity was 5.6 kg/kg, the fines level was 0.60% and the resin APS was 0.53 mm. The catalyst was light green.

### Comparative Example D

Examples I and II are repeated with the exception that the calculated amino alcohol to Cr mole ratio was 0.3:1.The catalyst productivity was 10 kg/kg, the fines level was 0.58% and the resin APS was 0.60 mm. The catalyst was yellow.

TABLE 1

| Example | II | B |
|---|---|---|
| Catalyst according to | I | A |
| Cr Loading, wt % | 0.38 | 0.38 |
| Ti Loading, wt % | 1.8 | 1.8 |
| Molar ratio | 0.8:1 | None |
| amino alcohol/Cr | | |
| Total Pressure, bar | 20.3 | 20.3 |
| Temperature, ° C. | 103 | 100 |
| Delta T ° C. | 4.939 | 4.767 |
| C₂ Partial Pressure, bar | 15 | 15 |
| C₆/C₂ Mole Ratio | 0.0014 | 0.0015 |
| H₂/C₂ Mole Ratio | 0.0206 | 0.0093 |
| Bed Weight, Kg | 50.24 | 49.43 |
| Bed Height, m | 1.09 | 1.19 |
| Fluidized Bulk Density, kg/m³ | 319.06 | 286.64 |
| Superficial Gas Velocity, m/s | 0.381 | 0.376 |
| Production Rate, kg/h | 11.2 | 12.8 |
| Average Residence Time, h | 4.5 | 4.0 |
| Plate Dp, mBar | 19.5 | 19.9 |
| Flow Index (I₂₁), dg/min | 9.78 | 10.63 |
| Flow Index (I₅), dg/mm | 0.39 | 0.48 |
| MFR (I₂₁/I₅) | 25 | 22.14 |
| Density, kg/m³ | 952.6 | 952.3 |
| Settled Bulk Density, kg/m³ | 461 | 431 |
| Fines, % | 0.16 | 0.61 |
| Resin APS, mm | 0.94 | 0.65 |
| Catalyst Productivity, kg/kg | 13.7 | 9.8 |
| Mw | 188764 | 168500 |
| Mn | 11265 | 15000 |
| Mz | 970693 | 690850 |
| Mz + 1 | 1957019 | 1412000 |
| Mz/Mw | 5.14 | 4.1 |
| PDI (Mw/Mn) | 16.8 | 11.2 |

As can be seen from Table 1:

The productivity of the catalyst composition according to the invention is about 40% higher compared to the catalyst composition according to the comparative example.

The combination of amino alcohol with the chromium oxide based catalyst composition produced a resin with higher APS and narrower PSD.

Furthermore, the fines content also significantly reduced by using the catalyst composition according to the invention in comparison to the comparative catalyst.

In the case (Comparative examples C and D) that the molar ratio amino alcohol: chromium ranges is outside the range 0.5:1 and 1:1 the result is less in comparison with the result of Example I.

1. A process for the production of polyethylene, comprising:
gas phase polymerisation of ethylene in the presence of a supported chromium oxide based catalyst composition which is modified with an amino alcohol;
wherein a molar ratio of amino alcohol:chromium ranges between 0.5:1 and 1:1;
wherein the support is silica having a surface area (SA) between 250 m²/g and 400 m²/g and a pore volume (PV) between 1.1 cm³/g and less than 2.0 cm³/g; and
wherein the chromium in the supported catalyst is at least 0.1% by weight and less than 0.5% by weight.

2. The process according to claim 1, wherein the molar ratio of amino alcohol:chromium ranges between 0.7:1 and 0.9:1.

3. The process according to claim 1, wherein the amino alcohol has the formula 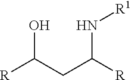
wherein the R groups may be, independently of one other the same or different a C₁-C₁₀ alkyl group, and R¹ is a C₃-C₈ cycloalkyl group or a C₄-C₁₆ alkyl substituted cycloalkyl group.

4. The process according to claim 3, wherein the amino alcohol is 4-(cyclohexylamino) pentan-2-ol or 4-[(2-methylcyclohexyl) amino]pentan-2-ol.

5. The process according to claim 1, wherein the catalyst comprises a titanium compound.

6. The process according to claim 5, wherein the titanium compound is at least one compound according to formulas Ti(OR¹)ₙX₄₋ₙ and Ti(R²)ₙX₄₋ₙ; and
wherein R¹ and R² represent an (C₁-C₂₀) alkyl group, (C₁-C₂₀) aryl group or (C₁-C₂₀) cycloalkyl group, X represents a halogen atom, and n represents a number satisfying 0≧n≦4.

7. Polyethylene obtainable with the process according to claim 1, wherein the polyethylene has
a high-load melt index (HLMI) of ≧5 g/10 min and ≦30 g/10 min (according to ISO 1133);
a M_{w}/Mₙ of ≧15 and ≦35 (according to size exclusion chromatography (SEC) measurement); and
a density of ≧935 kg/m³ and ≦960 kg/m³ (according to ISO1183).

8. An article prepared using the product according to claim 7.

9. The article of claim 8, wherein the article is a bottle or container.

10. A process for the production of polyethylene, comprising:
gas phase polymerizing ethylene in the presence of an amino alcohol modified, supported chromium oxide based catalyst composition;
wherein a molar ratio of amino alcohol:chromium ranges between 0.7:1 and 0.9:1;
wherein the support is silica having a surface area (SA) between 250 m²/g and 400 m²/g and a pore volume (PV) between 1.1 cm³/g and less than 2.0 cm³/g; and
wherein the chromium in the supported catalyst is at least 0.1% by weight and less than 0.5% by weight.

11. The process according to claim 10, wherein the amino alcohol is 4-(cyclohexylamino) pentan-2-ol or 4-[(2-methylcyclohexyl) amino]pentan-2-ol;
wherein the catalyst comprises at least one titanium compound according to formulas Ti(OR¹)ₙX₄₋ₙ and Ti(R²)ₙX₄₋ₙ; and
wherein R¹ and R² represent an (C₁-C₂₀) alkyl group, (C₁-C₂₀) aryl group or (C₁⁻C₂₀) cycloalkyl group, X represents a halogen atom, and n represents a number satisfying 0≧n≦4.
